(19) United States
(12) Patent Application Publication
(10) Pub. No.: US 2020/0034639 A1
(43) Pub. Date: Jan. 30, 2020

(54) INFORMATION PROVIDING SYSTEM, INFORMATION PROCESSING APPARATUS, AND INFORMATION PROVIDING METHOD

(71) Applicant: MICHITAKA FUKUDA, Kanagawa (JP)

(72) Inventor: MICHITAKA FUKUDA, Kanagawa (JP)

(73) Assignee: Ricoh Company, Ltd., Tokyo (JP)

(21) Appl. No.: 16/503,869

(22) Filed: Jul. 5, 2019

(30) Foreign Application Priority Data
Jul. 26, 2018 (JP) 2018-140645
Feb. 21, 2019 (JP) 2019-029581

(51) Int. Cl. G06K 9/00; G06T 7/20

(52) U.S. Cl. CPC G06K 9/00805; G08G 1/165; G06T 7/20

(57) ABSTRACT

An information providing system includes: one or more terminal devices that are respectively mounted on one or more vehicles; and an information processing apparatus communicable with the terminal devices via a network. Each of the terminal devices includes first circuitry configured to detect an object on a road and transmit terminal information including captured image data in which the object is captured and position information indicating a position where the object is detected to the information processing apparatus. The information processing apparatus includes second circuitry that receives the terminal information from at least one of the terminal devices that has detected the object on the road, determines whether the object in the captured image data included in the terminal information is a predetermined fallen object, when the object is determined to be the predetermined fallen object, registers the captured image data and the position information included in the terminal information that is received, and information for identifying the fallen object, in a memory as fallen object information of the fallen object, and provides information on the fallen object, based on the registered fallen object information.

### CROSS-REFERENCE TO RELATED APPLICATIONS

This patent application is based on and claims priority pursuant to 35 U.S.C. § 119(a) to Japanese Patent Application Nos. 2018-140645, filed on Jul. 26, 2018, and 2019-029581, filed on Feb. 21, 2019, in the Japan Patent Office, the entire disclosure of which is hereby incorporated by reference herein.

### BACKGROUND

### Technical Field

Embodiments of this disclosure relate to an information providing system, an information processing apparatus, and an information providing method.

### Description of the Related Art

There has been known an information providing system that provides information about fallen objects on roads to an information processing apparatus mounted on a vehicle such as an automobile.

For example, the information processing apparatus transmits information on a fallen object detected on a road to a communication device disposed along the road, and receives image data of a fallen object detected by another information processing apparatus mounted on another vehicle from the communication device for display.

Meanwhile, there is a need for timely collecting and managing information about fallen objects on roads at low cost. In particular, in order to detect fallen objects on a wide range of roads such as expressways, it is necessary to provide a large number of communication devices along the roads, which increases the cost. Even if a large number of communication devices are disposed along the roads and fallen objects can be detected on a wide range of roads such as expressways, there is no system for an operator or the like to centrally manage information about fallen objects.

### SUMMARY

Example embodiments of the present invention include an information providing system including: one or more terminal devices that are respectively mounted on one or more vehicles; and an information processing apparatus communicable with the terminal devices via a network. Each of the terminal devices includes first circuitry configured to detect an object on a road and transmit terminal information including captured image data in which the object is captured and position information indicating a position where the object is detected to the information processing apparatus. The information processing apparatus includes second circuitry that receives the terminal information from at least one of the terminal devices that has detected the object on the road, determines whether the object in the captured image data included in the terminal information is a predetermined fallen object, when the object is determined to be the predetermined fallen object, registers the captured image data and the position information included in the terminal information that is received, and information for identifying the fallen object, in a memory as fallen object information of the fallen object, and provides information on the fallen object, based on the registered fallen object information.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an example of a system configuration of an information providing system according to an embodiment;

FIG. 2 is a view of an example of a terminal device according to an embodiment;

FIG. 3 is a view illustrating an example of a display screen for an operator according to an embodiment;

FIG. 4 is a diagram illustrating an example of a hardware configuration of a computer according to an embodiment;

FIG. 5 is a diagram illustrating an example of a hardware configuration of the terminal device according to an embodiment;

FIGS. 6A and 6B (FIG. 6) are a diagram illustrating an example of a functional configuration of the information providing system according to an embodiment;

FIGS. 7A and 7B are flowcharts illustrating examples of a terminal information transmission process according to an embodiment;

FIG. 8 is a flowchart illustrating an example of a terminal information registration process according to an embodiment;

FIG. 9 is a flowchart illustrating an example of the terminal information registration process according to an embodiment;

FIGS. 10A and 10B (FIG. 10) are a flowchart illustrating an example of the terminal information registration process according to an embodiment;

FIG. 11 is a flowchart illustrating an example of a display screen display process according to an embodiment;

FIGS. 12AA and 12AB (FIG. 12A) are a flowchart illustrating an example of the display screen display process according to an embodiment;

FIGS. 12BA and 12BB (FIG. 12B) are a flowchart illustrating an example of the display screen display process according to an embodiment;

FIG. 13 is a view illustrating another example of the display screen for an operator according to an embodiment;

FIG. 14 is a flowchart illustrating an example of a status change process according to an embodiment;

FIG. 15 is a flowchart illustrating an example of an alert information notification process according to an embodiment; and

FIG. 16 is a flowchart illustrating an example of a voice information output process according to an embodiment.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Embodiments of this disclosure will be described hereinafter with reference to the accompanying drawings.

### <System Configuration>

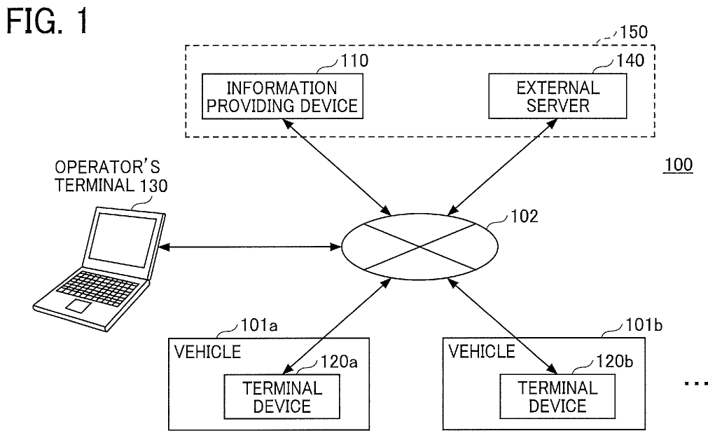

FIG. 1 is a diagram illustrating an example of a system configuration of an information providing system according to an embodiment. An information providing system 100 includes terminal devices 120a, 120b, . . . respectively mounted on vehicles 101a, 101b, . . . and an information providing device 110 that is communicable with the terminal devices 120a, 120b, . . . via a network 102.

In the following description, “terminal device 120” is used to indicate a terminal device arbitrarily selected from among the terminal devices 120a, 120b, . . . . In addition, “vehicle 101” is used to indicate a vehicle arbitrarily selected from among the vehicles 101a, 101b, . . . . The number of the vehicles 101 and the terminal devices 120 illustrated in FIG. 1 is an example, and any other numbers of the vehicles 101 and the terminal devices 120 may be provided.

In the example of FIG. 1, the information providing system 100 also includes a terminal 130, operated by an operator such as a system administrator, and an external server 140.

The terminal device 120 is, for example, an information terminal mounted on the vehicle 101 such as an automobile and a motorcycle, and executes an application program (hereinafter referred to as “application”) for the information providing system 100. The terminal device 120 may be, for example, a general-purpose information terminal such as a smartphone and a tablet terminal, or may be an in-vehicle information terminal such as a drive recorder and a car navigation device. As an example, the following description will be given assuming that the terminal device 120 is a general-purpose information terminal such as a smartphone and a tablet terminal.

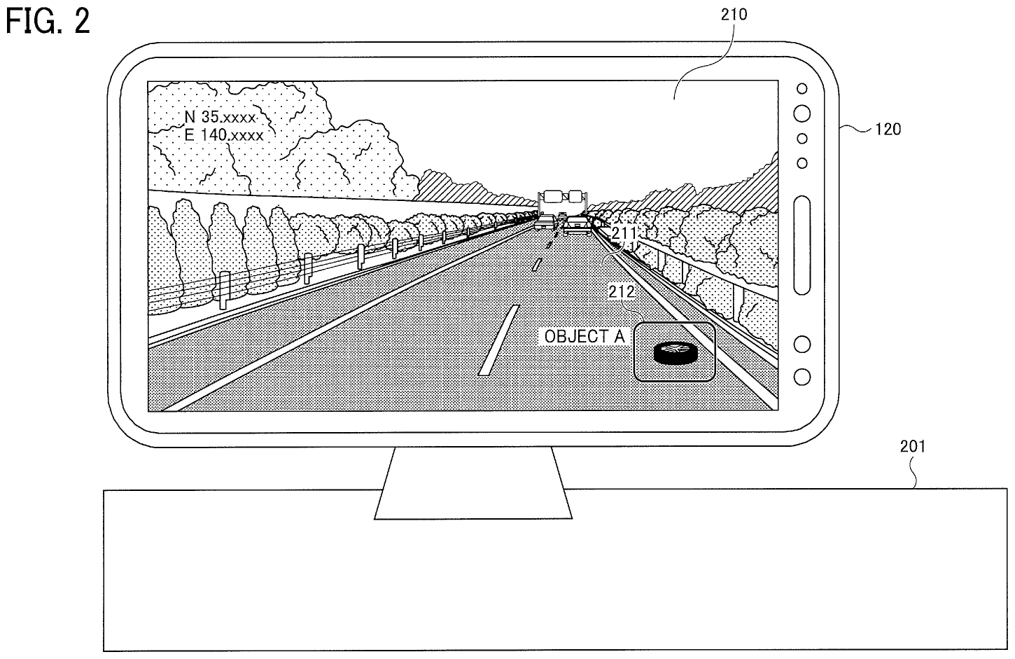

As illustrated in FIG. 2, the terminal device 120 is attached to, for example, a dashboard 201 of the vehicle 101 and executes the application for the information providing system 100 to capture a road 211 around (ahead of) the vehicle 101 and display the captured image of the road 211 (simply referred to as the” road 211”) on a display screen 210.

The terminal device 120 also performs image processing on image data obtained by capturing the periphery of the vehicle 101 to detect a predetermined object 212 on the road 211.

When the predetermined object 212 is detected on the road 211, the terminal device 120 transmits terminal information including image data in which the object 212 is captured and position information indicating the position where the object 212 is detected to the information providing device 110.

The predetermined object 212 is an object estimated to be a fallen object on a road, and it is not necessary to specify what the object is. For example, when the road is an expressway, there are hardly placed objects other than other vehicles on the road in general, and thus the terminal device 120 may detect an object of a predetermined size smaller than other vehicle as the predetermined object 212. Alternatively, the terminal device 120 may detect a stationary object of a predetermined size smaller than other vehicle as the predetermined object 212.

In addition, the terminal device 120 may extract feature information of an object on the road 211 from the image data obtained by capturing the periphery of the vehicle 101 and detect an object whose similarity to the feature information of a fallen object stored in advance is equal to or more than a threshold as the predetermined object 212.

Furthermore, the terminal device 120 may determine whether an object on the road 211 is a fallen object by using a prediction model that learns in advance by machine learning. Machine learning is a technology for causing a computer to acquire a human-like learning ability. That is, machine learning is a technology for causing a computer to autonomously generate an algorithm necessary for determination such as data identification from learning data taken in advance and apply the algorithm to new data to make predictions. The learning method for machine learning is not particularly limited and may be supervised learning, unsupervised learning, semi-supervised learning, reinforcement learning, deep learning, or any combination of these learning methods.

The information providing device 110 is an information processing apparatus implemented by a computer or a system including a plurality of such information processing apparatuses. The information providing device 110 receives the above-described terminal information transmitted from the terminal device 120 and determines whether the object 212 included in the image data of the terminal information is a predetermined fallen object.

As an example, the information providing device 110 uses an image recognition engine provided by the external server 140 or the like to acquire a character string representing the image data. When the acquired character string includes a predetermined keyword (for example, a tire, a wheel cover, a fallen stone, and a cardboard box), the information providing device 110 determines that the object 212 captured in the image data is a predetermined fallen object.

As an example of the image recognition engine provided by the external server 140, Cloud Vision API, which is a learned machine learning, application programming interface (API) provided by Google (Registered Trademark), can be used.

As another example, the information providing device 110 may use an image recognition engine provided with the information providing device 110 itself or the like to determine whether the image data includes a predetermined fallen object. For example, the image recognition engine of the information providing device 110 stores in advance a prediction model created by machine learning using feature values extracted from a plurality of pieces of image data in which predetermined fallen objects are captured. In addition, the information providing device 110 inputs image data included in the terminal information to the prediction model stored in advance to acquire information for determining whether the object 212 captured in the image data is a predetermined fallen object or indicating the fallen object (for example, a character string).

When the object 212 captured in the image data is a predetermined fallen object, the information providing device 110 stores fallen object information including image data corresponding to the fallen object, position information, and information for identifying the fallen object (for example, the name and type of the fallen object) in a memory.

For example, the information providing device 110 may store the fallen object information in a memory for a storage service or a database service provided by the external server 140, or may store the fallen object information in a memory included in the information providing device 110.

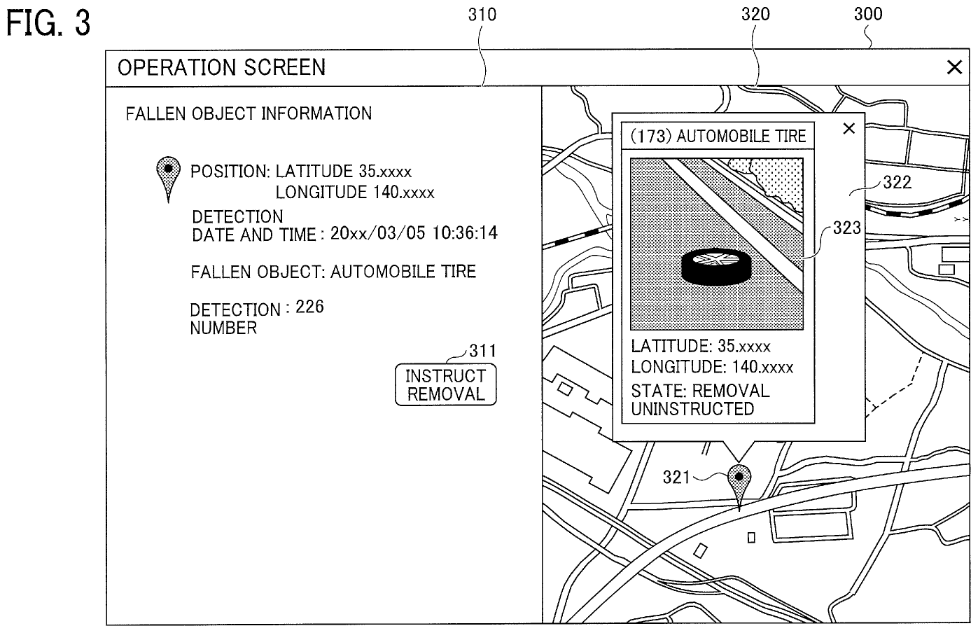

The information providing device 110 uses one or more pieces of the fallen object information stored in the memory to provide information of a fallen object on a road to the operator's terminal 130 or other devices. For example, the information providing device 110 has a web server function, which displays a display screen 300 illustrated in FIG. 3 using a web browser of the operator's terminal 130 connected to the web server.

FIG. 3 is a view illustrating an example of a display screen for an operator according to an embodiment. A map 320 around a fallen object, a pin 321 that is an example of a display element indicating the position of the fallen object, fallen object information 310 that is the information of the fallen object, and the like are displayed on the display screen 300 for the operator illustrated in FIG. 3.

The operator using the operator's terminal 130 recognizes the position of the fallen object by, for example, the position of the pin 321 displayed on the map 320 and the position information (latitude and longitude) included in the fallen object information 310. Further, the operator can select the pin 321 displayed on the map 320 to display an information window 322 that displays an image 323 of the fallen object, for example.

The operator can recognize the fallen object by the image 323 of the fallen object and information for identifying the fallen object included in the fallen object information 310 (for example, “automobile tire”).

The operator can also manage the status (management state) of the fallen object by using the display screen 300. In the example of FIG. 3, the display screen 300 displays an “instruct removal” button 311 that is an example of a button for managing the status of a fallen object.

For example, the operator instructs a worker near the fallen object to remove (collect) the fallen object and then selects the “instruct removal” button 311. The status of the fallen object can thus be changed to “removal instructed”. In addition, it may be configured that the operator's terminal 130 detects or recognizes that the fallen object to be collected has been actually collected by the worker near the fallen object. The “instruct removal” button 311 is thus changed to a “removal completed” button, and an operation of the removal completion by the operator can be accepted.

As illustrated in FIG. 3, the fallen object information 310 on the display screen 300 preferably includes information about “detection number” that indicates the number of times a fallen object is detected. Based on this information, the operator can determine the probability of the fallen object information 310.

As described above, the information providing device 110 receives terminal information transmitted from the terminal devices 120, and when the object 212 in the image data included in the terminal information is a predetermined fallen object, the information providing device 110 stores the information of the fallen object in a storage unit 609. In addition, the information providing device 110 provides information such as the position, image, and type of a fallen object to the operator's terminal 130 using one or more pieces of information of fallen objects stored in the memory, and manages the status of the fallen object.

According to the present embodiment, the information providing system 100 can facilitate timely collection of information of fallen objects on a wide range of roads at low cost.

The system configuration of the information providing system 100 illustrated in FIG. 1 is an example. For example, the information providing device 110 and the external server 140 may operate on the same cloud server (another example of the information providing device) 150 or the like, or at least some of the functions of the external server 140 may be included in the information providing device 110.

In addition, the operator may display, for example, the display screen 300 for an operator illustrated in FIG. 3 on a display device included in the information providing device 110 instead of the operator's terminal 130.

### <Hardware Configuration>

### (Hardware Configurations of Information Providing Device, External Server 140, and Operator's Terminal)

The information providing device 110 and the external server 140 illustrated in FIG. 1 are, each or collectively, implemented by a general computer or a plurality of computers. The operator' terminal 130 also has a general computer configuration. Consequently, an example of a hardware configuration of the general computer will be described.

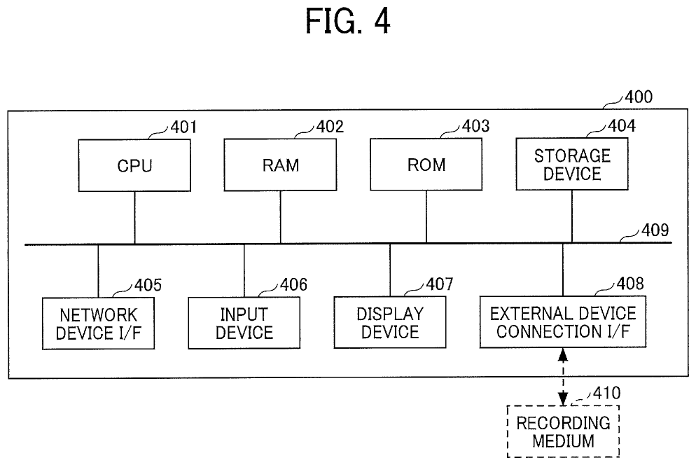

FIG. 4 is a diagram illustrating an example of a hardware configuration of a computer according to an embodiment. A computer 400 includes a central processing unit (CPU) 401, a random access memory (RAM) 402, a read only memory (ROM) 403, a storage device 404, a network device I/F (Interface) 405, an input device 406, a display device 407, an external device connection I/F 408, a bus 409, and other components.

The CPU 401 is a processor that reads programs and data stored in the ROM 403 and the storage device 404 onto the RAM 402 and executes a process, thus implementing each function of the computer 400. The RAM 402 is a volatile memory used as a work area for the CPU 401 or the like. The ROM 403 is a non-volatile memory that holds programs and data even after the power supply is switched off, and may include an erasable programmable read only memory (EPROM), a Flash Memory, and other memories.

The storage device 404 is, for example, a large-capacity storage device such as a hard disk drive (HDD) and a solid state drive (SSD), and stores an operating system (OS), applications, various data, and the like. The network device I/F 405 is a communication interface for connecting the computer 400 to the network 102.

The input device 406 is, for example, a operatoring device such as a mouse, a keyboard, or an input device such as a touch panel that receives an input by a touch operation, and is used to input operation signals to the computer 400. The display device 407 is, for example, a display that displays a result of processing by the computer 400 and the like.

The external device connection I/F 408 is an interface for connecting an external device to the computer 400. The external device may include, for example, a storage medium 410. The bus 409 is connected to each of the components described above and transmits address signals, data signals, various control signals, for example.

### (Hardware Configuration of Terminal Device)

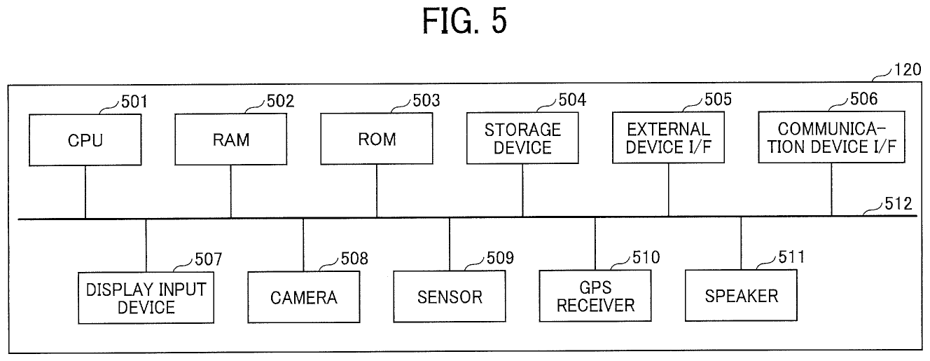

FIG. 5 is a diagram illustrating an example of a hardware configuration of a terminal device according to an embodiment. The terminal device 120 has a configuration of a general computer. In particular, the terminal device 120 includes, for example, a CPU 501, a RAM 502, a ROM 503, a storage device 504, an external device I/F 505, a communication device I/F 506, a display input device 507, a camera 508, a sensor 509, a global positioning system (GPS) receiver 510, a speaker 511, a bus 512, and other components.

The CPU 501 is a processor that reads programs and data stored in the ROM 503 and the storage device 504 onto the RAM 502 and executes a process, thus implementing each function of the terminal device 120. The RAM 502 is a volatile memory used as a work area for the CPU 501 or the like. The ROM 503 is a non-volatile memory that holds programs and data even after the power supply is switched off, and may include an erasable programmable read only memory (EPROM), a Flash Memory, and other memories. The storage device 504 is, for example, a storage device such as HDD, SSD and flash ROM, and stores an OS, application programs, various types of data, and the like.

The external device OF 505 is an interface for connecting a storage medium such as a universal serial bus (USB) memory and an external device such as a car navigation device, a camera, a sensor, and a drive recorder to the terminal device 120, for example.

The communication device I/F 506 is, for example, a wireless communication device that connects the terminal device 120 to the network 102 via a mobile communication network such as a long term evolution (LTE) to communicate with the information providing device 110 and other devices. The communication device I/F 506 includes an antenna, a wireless transmission and reception circuit, a communication control circuit, and the like. In addition, when the terminal device 120 is a device compatible with an in-vehicle network, the communication device I/F 506 may use, for example, a controller area network (CAN). In this case, the terminal device 120 may be connected via a bridge or a gateway to the external Internet.

The display input device 507 includes, for example, a device having an input function and a display function such as a touch panel display. The camera 508 includes an image sensor for capturing an image around a vehicle, an image processing device, and other components.

The sensor 509 includes a sensor such as an acceleration sensor and a gyro sensor. The GPS receiver 510 includes a position information acquisition device that receives positioning signals transmitted from GPS satellites and outputs position information. The speaker 511 includes a voice circuit that generates a voice signal, a speaker that converts a voice signal into a voice and outputs the voice, and the like. The bus 512 is connected to each of the configurations described above and transmits address signals, data signals, various control signals, for example.

### <Functional Configuration>

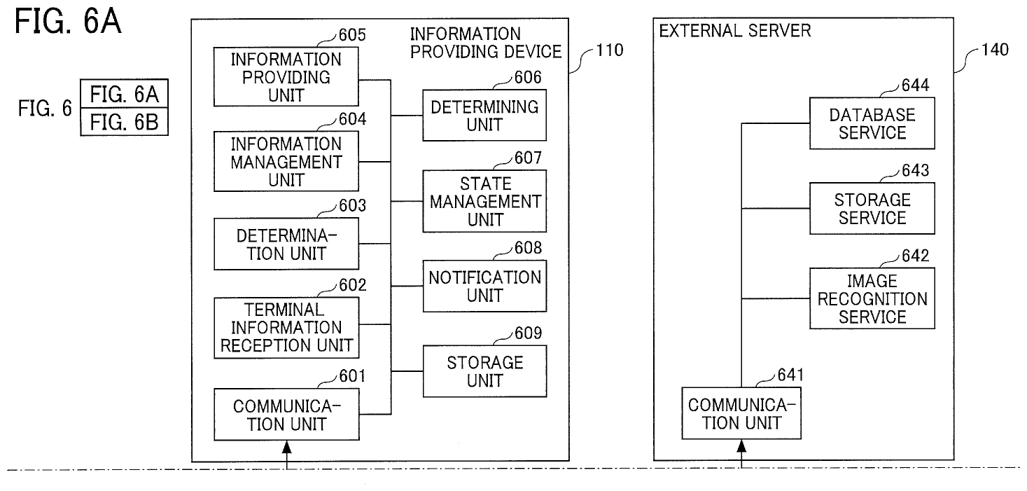

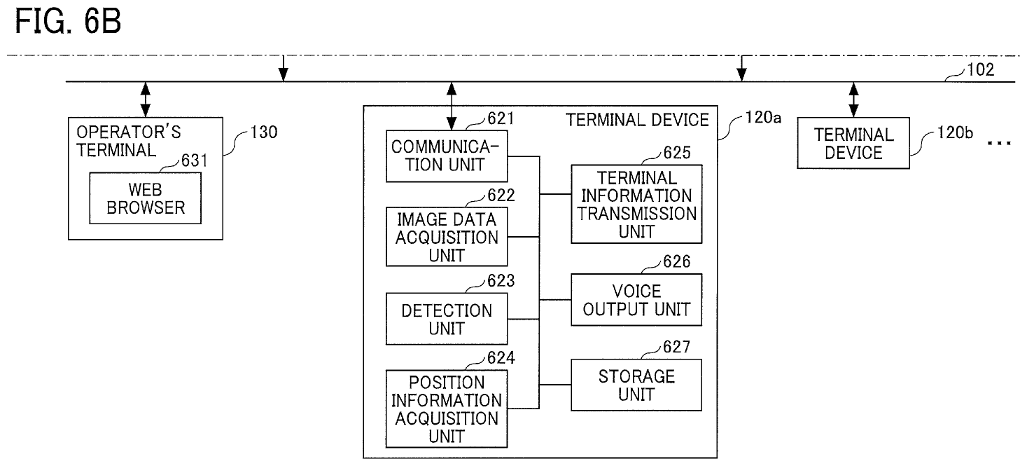

FIG. 6 is a diagram illustrating an example of a functional configuration of an information providing system according to an embodiment. In FIG. 6, it is assumed that the terminal device 120b has the same functional configuration as the terminal device 120a.

### (Functional Configuration of Terminal Device)

The terminal device 120 includes, for example, a communication unit 621, an image data acquisition unit 622, a detection unit 623, a position information acquisition unit 624, a terminal information transmission unit 625, a voice output unit 626, a storage unit 627, and other components.

The CPU 501 of the terminal device 120, illustrated in FIG. 5, executes a predetermined program, to implement the functional configurations above-described, for example. Some of the functional configurations described above may be implemented by hardware illustrated in FIG. 5.

The communication unit 621 connects the terminal device 120a to the network 102 by, for example, using the communication device I/F 506 illustrated in FIG. 5, thus communicating with the information providing device 110 and other devices.

The image data acquisition unit 622 acquires image data (for example, a moving image) obtained by capturing a road around (for example, ahead of) the vehicle 101 using, for example, the camera 508 illustrated in FIG. 5. The image data acquisition unit 622 may acquire image data obtained by capturing a road around a vehicle using not only the camera 508 but also an external device such as a camera and a drive recorder mounted on the vehicle 101.

The detection unit 623 detects a predetermined object on a road from the image data obtained by capturing a road around the vehicle 101, which is acquired by the image data acquisition unit 622. For example, as illustrated in FIG. 2, the detection unit 623 analyzes image data obtained by capturing the road 211 around the vehicle 101 with the camera 508 included in the terminal device 120 attached to the dashboard 201 of the vehicle 101 or the like to detect the predetermined object (object A) 212 on the road 211.

The predetermined object 212 is an object estimated to be a fallen object on the road 211 as described above. The predetermined object 212 may be an object of a predetermined size on the road 211 or may be an object whose similarity to feature information of a fallen object stored in advance is equal to or higher than a threshold, as described above. The predetermined object 212 may be an object determined to be a fallen object on the road 211 by using a prediction model learned in advance by machine learning.

The position information acquisition unit 624 acquires position information at a location where the object 212 is detected on the road 211, by using, for example, the GPS receiver 510 in FIG. 5. The position information acquisition unit 624 may acquire position information by further using self-contained navigation that utilizes the sensor 509, or may acquire position information from a navigation device mounted on the vehicle 101.

When the detection unit 623 detects the object 212, the terminal information transmission unit (transmitter) 625 transmits terminal information including image data in which the object 212 is captured and position information indicating the position of a location where the object 212 is detected to the information providing device 110. For the image data in which the object 212 is captured, for example, the image data (still image) in which the object 212 is captured is obtained from the image data (moving image) acquired by the image data acquisition unit 622 for use.

The terminal information preferably includes, for example, identification information for identifying each of the terminal device 120, the vehicle 101, and a user and time information (for example, date and time) indicating the time when the object 212 is detected. The identification information of the terminal device 120 may include the product name, model number, and manufacturing serial number of the terminal device 120, for example. The identification information of the vehicle 101 may include a vehicle type, a model year, a vehicle registration number, and a current traveling speed of a vehicle, for example. The identification information of a user may include the name of a driver who drives a vehicle having the terminal device 120 mounted thereon and registrant information of that vehicle, for example.

In addition to the process described above, the terminal information transmission unit 625 transmits position information indicating the position of the terminal device 120 (or vehicle) to the information providing device 110 at a predetermined time (for example, at an interval of one minute).

The voice output unit 626 generates a voice message that calls attention to a fallen object based on alert information (for example, text message) notified from the information providing device 110 and outputs the voice message generated using the speaker 511 illustrated in FIG. 5. The voice output unit 626 may output the audio message generated by using a voice circuit or a speaker included in the vehicle 101.

The storage unit 627 is implemented by, for example, a program executed by the CPU 501 in FIG. 5, the storage device 504, and the RAM 502, and stores various data and information such as the identification information of the terminal device 120, the image data acquired by the image data acquisition unit 622, and the alert information received from the information providing device 110.

### (Functional Configuration of Information Providing Device)

The information providing device 110 includes, for example, a communication unit 601, a terminal information reception unit 602, a determination unit 603, an information management unit 604, an information providing unit 605, a determining unit 606, a state management unit 607, a notification unit 608, the storage unit 609, and other components.

The CPU 401 of the information providing device 110, illustrated in FIG. 4, executes a predetermined program, thus implementing the functional configurations above-described, for example. Some of the functional configurations described above may be implemented by hardware.

The communication unit 601 connects the information providing device 110 to the network 102 by, for example, using the network device OF 405 illustrated in FIG. 4, thus communicating with the terminal device 120, the operator's terminal 130, the external server 140, and other devices.

The terminal information reception unit (receiver) 602 receives terminal information including image data in which an object is captured and position information indicating the position where the object is detected, which is transmitted from the terminal device 120 when a predetermined object on a road is detected.

The determination unit 603 determines whether the object captured in the image data included in the terminal information received by the terminal information reception unit 602 is a predetermined fallen object.

As an example, the determination unit 603 transmits image data to an image recognition service 642, which is an image recognition engine provided by the external server 140, and acquires a character string and an illustrative image that indicate the image data returned from the image recognition service 642. When the character string acquired from the image recognition service 642 includes a predetermined keyword (for example, a tire, a wheel cover, a fallen stone, and a cardboard box), the determination unit 603 determines that the object captured in the image data is a predetermined fallen object. When the illustrative image acquired from the image recognition service 642 includes a predetermined illustrative image (for example, an illustrative image of a tire, a wheel cover, a fallen stone, or a cardboard box), the determination unit 603 determines that the object captured in the image data is a predetermined fallen object.

As the image recognition service 642 provided by the external server 140, Cloud Vision API, which is a learned machine learning API, may be used, for example.

As another example, the determination unit 603 may store in advance a prediction model created by machine learning using feature values extracted from a plurality of pieces of image data in which predetermined fallen objects are captured in the storage unit 609. In this case, the determination unit 603 inputs image data included in the terminal information to the prediction model stored in advance to acquire information for determining whether the object captured in the image data is a predetermined fallen object or indicating the fallen object (for example, a character string and an illustrate image).

When the determination unit 603 determines that the object captured in the image data included in the terminal information is a predetermined fallen object, the information management unit 604 manages fallen object information including the image data and the position information included in the terminal information and information for identifying a fallen object. Specifically, the information management unit 604 may register the fallen object information to a storage service 643 and a database service 644 provided by the external server 140, or may store the fallen object information in the storage unit 609 of the information providing device 110.

The information for identifying a fallen object is, for example, a character string representing information such as the name, type, and size of a fallen object, and a character string (for example, “tire”) selected by the determination unit 603 among a plurality of character strings (tag information) acquired from the image recognition service 642 is used. In addition, the information for identifying a fallen object is, for example, an illustrative image for visually recognizing a fallen object, and an illustrative image (for example, “image of tire”) selected by the determination unit 603 among a plurality of illustrative images acquired from the image recognition service 642 is used.

The information management unit 604 preferably manages fallen objects detected by the terminal devices 120 within a preset range (for example, within a radius of 15 m from the center) as identical fallen objects. As another example, the information management unit 604 may determine the item of a fallen object (for example, a tire, a wheel cover, a fallen stone, and a cardboard box) using a prediction model learned in advance by machine learning, and for example, when the items of fallen objects match, these objects are managed as identical fallen objects.

The information providing unit 605 uses one or more pieces of fallen object information managed by the information management unit 604 to provide information of a fallen object on a road. For example, the information providing unit 605 has a web server function and displays the display screen 300 for the operator illustrated in FIG. 3 using a web browser 631 of the operator's terminal 130 accessing the web server.

The determining unit 606 determines position information of a plurality of fallen objects that are managed by the information management unit 604 as identical fallen objects. For example, the determining unit 606 averages the position information of the fallen objects managed by the information management unit 604 as the identical fallen objects and determines the average value of the position information as the position information of the fallen object. The determining unit 606 may determine the position information of the fallen object by using other representative values such as a mode value and a median value instead of the average value.

When the number of fallen objects managed as the identical fallen objects exceeds a predetermined number, the information providing unit 605 preferably determines that the accuracy of the position information determined by the determining unit 606 is improved, and changes the predetermined range to a narrower range (for example, changes from 15 m to 5 m).

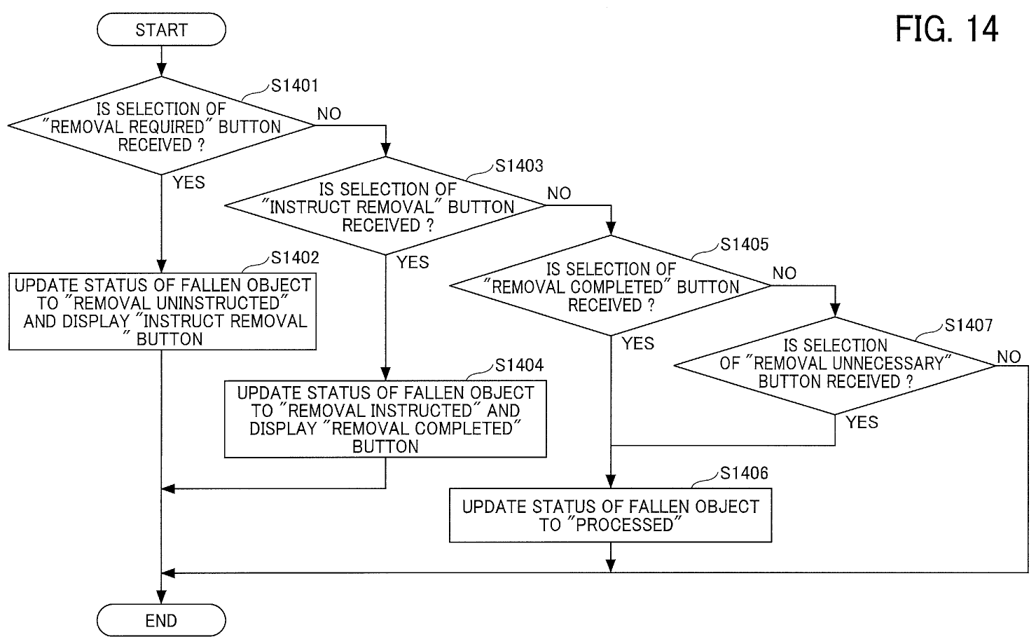

The state management unit 607 manages the management state (hereinafter, referred to as “status”) of a fallen object managed by the information management unit 604. For example, the information providing unit 605 displays a status button such as the “instruct removal” button 311 on the display screen 300 for the operator illustrated in FIG. 3 and receives an operation of the status button by the operator. In addition, the state management unit 607 performs a status change process of changing the status of the fallen object according to the operation received by the information providing unit 605. The status change process performed by the state management unit 607 will be described later with reference to FIG. 14.

When a fallen object is present within a predetermined range (for example, within a radius of 2 km) with respect to the position of the vehicle 101 or the terminal device 120, the notification unit 608 notifies the terminal device 120 of alert information about the fallen object.

This alert information may be a text message such as “There is fallen object within 2 km, so drive carefully.” and “There is automobile tire near 2 km from here, so drive carefully.” However, the alert information is not limited to the text message and may be a preset error code, voice data, and the like.

With this alert information, the terminal device 120 outputs voice information corresponding to the alert information using the voice output unit 626, thus safely notifying a driver of the vehicle 101 on which the terminal device 120 is mounted of information about a fallen object. The timing of outputting the voice information corresponding to the alert information may be changed depending on the current traveling speed of the vehicle 101 on which the terminal device 120 is mounted and the traffic volume of a road (lane) on which the vehicle 101 travels (that is, the time to reach the fallen object). This is because, for example, the time required to reach the fallen object in a case where the distance to the fallen object is 1 km and the traveling speed of the vehicle 101 is 50 km/h is different from the time required to reach the fallen object in a case where the distance to the fallen object is 1 km and the travelling speed of the vehicle 101 is 100 km/h. In the above case, it takes 72 seconds for 50 km/h and 36 seconds for 100 km/h. When the vehicle 101 travels at 100 km/h, the notification has to be made earlier.

### (Functional Configuration of External Server)

The external server 140 is implemented by, for example, an information processing apparatus or an information processing system that provides various cloud services provided by a service provider such as Google. In the example of FIG. 6, the external server 140 includes a communication unit 641, the image recognition service 642, the storage service 643, the database service 644, and other components.

The image recognition service 642 is not limited to the Cloud Vision API described above and image recognition services provided by various service providers can be used.

The storage service 643 is an online storage service provided by the external server 140, and stores, for example, image data and files.

The database service 644 is a cloud database provided by the external server 140 and is, for example, Cloud SQL provided by Google.

For the external server 140, a plurality of the external servers 140 provided by different service providers may be used. Each of the services provided by the external server 140 may have any configuration, and thus a detailed description thereof will be omitted.

### (Functional Configuration of Operator's Terminal)

The operator's terminal 130 is implemented by an information processing apparatus installed with the web browser 631. The web browser 631 may be a general web browser that is communicable to a web server to enable browsing of web pages, and thus a detailed description thereof will be omitted.

### <Flow of Process>

Next, a flow of processing to provide information, performed by the information providing system 100, according to the present embodiment will be described.

(Terminal information Transmission Process)

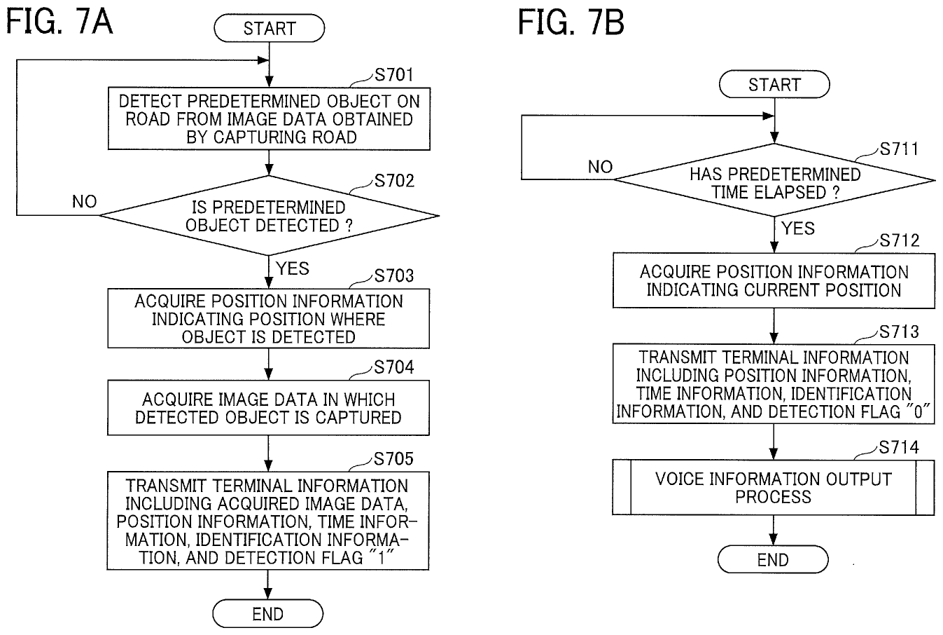

FIGS. 7A and 7B are flowcharts illustrating examples of a terminal information transmission process according to an embodiment. The terminal device 120 repeatedly performs a process illustrated in FIG. 7A and a process illustrated in FIG. 7B concurrently to transmit terminal information to the information providing device 110.

The process illustrated in FIG.7A is an example of the terminal information transmission process performed when the terminal device 120 detects a predetermined object on a road. As of the start of the processes illustrated in FIGS. 7A and 7B, it is assumed that the terminal device 120 is attached to the dashboard 201 of the vehicle 101 as illustrated in FIG. 2 and is executing the application for the information providing system 100.

At step S701, the detection unit 623 of the terminal device 120 detects a predetermined object on a road from image data obtained by capturing a road around the vehicle 101, which is acquired by the image data acquisition unit 622, for example, as described above with reference to FIG. 2.

At step S702, the terminal device 120 determines whether the predetermined object is detected at step S701 and when the predetermined object is detected (“YES” at S702), the process proceeds to step S703. On the other hand, when the predetermined object is not detected (“NO” at S702), the terminal device 120 repeats the processes at steps S701 and S702.

When the process proceeds to step S703, the terminal information transmission unit 625 of the terminal device 120 uses the position information acquisition unit 624 to acquire position information indicating a position where the detection unit 623 has detected the predetermined object. As an example, the terminal information transmission unit 625 acquires position information at the time operator when the predetermined object is detected among position information continuously output by the position information acquisition unit 624.

As another example, the terminal information transmission unit 625 may acquire position information at the time operator when the process at step S703 is performed. This is because, for example, as illustrated in FIG. 2, at the time operator when the predetermined object 212 is detected from image data obtained by capturing the road 211, a slight difference is present between the position of the terminal device 120 and the position of the predetermined object 212. For example, when the vehicle 101 travels toward the predetermined object 212, the delay time from the detection of the predetermined object to the process at step S703 is very small. For this reason, it is assumed that the distance (difference) between the position of the terminal device 120 and the position of the predetermined object 212 is reduced.

At step S704, the terminal information transmission unit 625 of the terminal device 120 acquires the image data in which the object detected at step S701 is captured. For example, the terminal information transmission unit 625 captures image data (still image data) at the time operator when the detection unit 623 detects the predetermined object from image data (moving image data) acquired by the image data acquisition unit 622.

The process at step S704 may be performed prior to the process at step S703, or may be performed in parallel with the process at step S703.

At step S705, the terminal information transmission unit 625 of the terminal device 120 transmits terminal information including the image data acquired at step S703 and the position information acquired at step S704 to the information providing device 110.

The terminal information to be transmitted to the information providing device 110 at step S705 preferably includes identification information for identifying the terminal device 120, time information indicating the time when the predetermined object is detected, a detection flag “1” indicating that the predetermined object is detected, and the like.

For the time when the predetermined object is detected, the time when the terminal information transmission unit 625 transmits the terminal information may be used. Alternatively, for the time when the predetermined object is detected, the time when the information providing device 110 receives the terminal information may be used. In this case, the terminal information does not have to include the time information.

The detection flag “1” may be added by the information providing device 110 when the terminal information includes the image data. In this case, the terminal information does not have to include the detection flag.

The process illustrated in FIG.7B is an example of the terminal information transmission process performed by the terminal device 120 in parallel with the process illustrated in FIG. 7A.

At step S711, the terminal information transmission unit 625 of the terminal device 120 determines, for example, whether a predetermined time (for example, one minute or the like) has elapsed since the last transmission of the terminal information.

If the predetermined time has elapsed, the terminal device 120 shifts the process to step S712. On the other hand, if the predetermined time has not elapsed, the terminal device 120 returns the process to step S711, and repeatedly performs the same process until the predetermined time elapses.

When the process proceeds to step S712, the terminal information transmission unit 625 of the terminal device 120 acquires position information indicating the current position of the terminal device 120 (or the vehicle 101) by using the position information acquisition unit 624.

At step S713, the terminal information transmission unit 625 of the terminal device 120 transmits terminal information including the position information acquired at step S712, the current time information, identification information for identifying the terminal device 120, a detection flag “0”, and the like, to the information providing device 110.

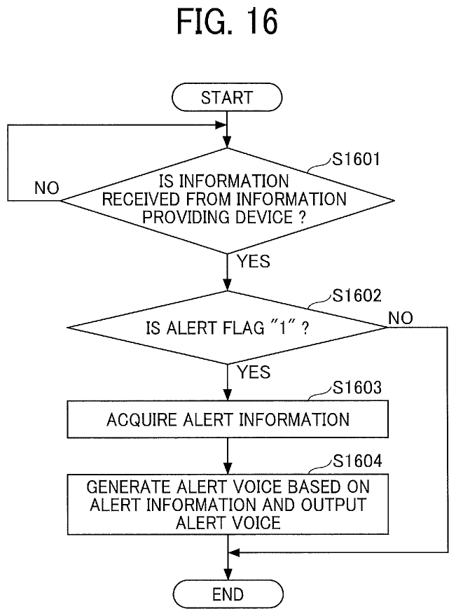

At step S714, when the terminal device 120 receives the alert information about a fallen object notified from the information providing device 110, the terminal device 120 performs a voice information output process of outputting voice information for calling attention to the fallen object. The specific content of the voice information output process will be described later with reference to FIG. 16.

The terminal information transmission process illustrated in FIGS. 7A and 7B is an example. For example, the terminal information transmission unit 625 may perform the processes at steps S701 to S705 and the processes at steps S711 to S713 in parallel.

(First Example of Terminal information Registration Process)

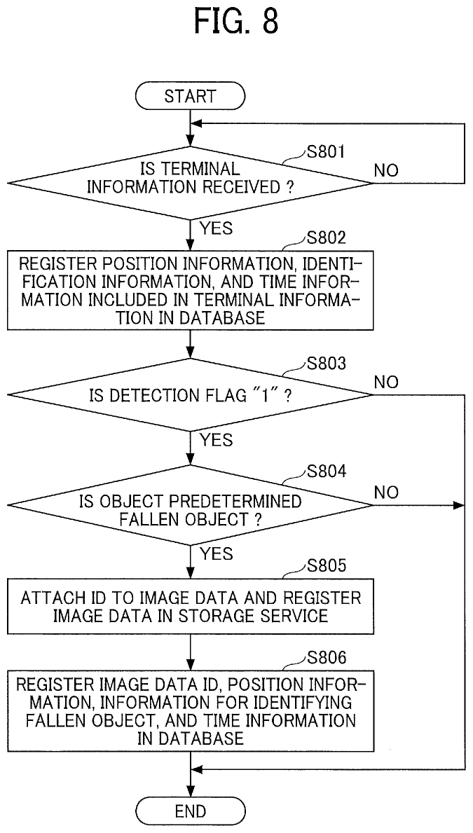

FIG. 8 is a flowchart illustrating an example of a terminal information registration process according to an embodiment. This process is an example of a process performed when the information providing device 110 receives terminal information transmitted from the terminal device 120.

At step S801, when the information providing device 110 receives the terminal information transmitted from the terminal device 120, the information providing device 110 performs the processes at step S802 and subsequent steps.

At step S802, the information management unit 604 of the information providing device 110 registers position information, time information, and identification information included in the terminal information in a database such as the database service 644, for example. The information management unit 604 may store the position information, the time information, and the identification information included in the terminal information in a database stored in the storage unit 609 of the information providing device 110.

At step S803, the information providing device 110 determines whether the detection flag included in the terminal information is “1”.

If the detection flag is “1” (“YES” at S803), the information providing device 110 shifts the process to step S804. On the other hand, when the detection flag is “0” (“NO” at S803), the information providing device 110 ends the process. The information providing device 110 may shift the process to step S804 regardless of the detection flag, for example, when image data is included in the terminal information.

When the process proceeds to step S804, the determination unit 603 of the information providing device 110 determines whether the object captured in the image data included in the terminal information is a predetermined fallen object.

For example, the determination unit 603 notifies the image recognition service 642 provided by the external server 140 of the image data included in the terminal information to request image recognition. The image recognition service 642 then notifies the information providing device 110 of one or more character strings indicating the object included in the image through the learned machine learning API. When one or more character strings notified from the image recognition service 642 include a predetermined keyword such as a tire, a wheel cover, a fallen stone, and a cardboard box, the determination unit 603 determines that the object captured in the image data is a predetermined fallen object.

As described above, the determination unit 603 may perform the above-described determination using a prediction model stored in advance in the storage unit 609 instead of the image recognition service 642.

When the object captured in the image data included in the terminal information is a predetermined fallen object, the information providing device 110 performs processes at steps S805 and S806. On the other hand, if the object captured in the image data included in the terminal information is not a predetermined fallen object, the information providing device 110 ends the process.

At steps S805 and S806, the information management unit 604 of the information providing device 110 stores fallen object information including the image data corresponding to the fallen object, the position information, and the information for identifying the fallen object in the memory.

For example, at step S805, the information management unit 604 attaches an ID for identifying image data to the image data (image data corresponding to the fallen object) included in the terminal information and registers the image data in the storage service 643 of the external server 140 or the like.

At step S806, the information management unit 604 of the information providing device 110 registers the ID of the image data, the position information included in the terminal information (position information corresponding to the fallen object), the identification information for identifying the fallen object, and the time information included in the terminal information in a database such as the database service 644.

With the process described above, the information management unit 604 can acquire the identification information of the terminal device 120, the position information, and the time information every predetermined time interval and store these pieces of information in the memory.

When the detection flag is “1” and the object captured in the image data is a predetermined fallen object, the information management unit 604 stores the image data corresponding to the fallen object, the position information, the information for identifying the fallen object, and the time information in the memory.

### (Second Example of Terminal Information Registration Process)

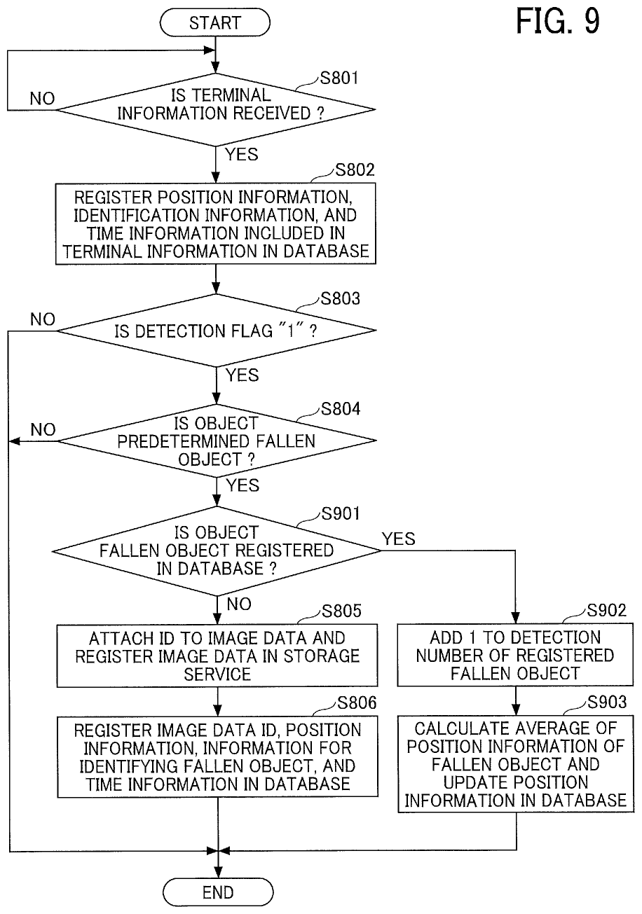

The terminal information registration process illustrated in FIG. 8 is an example. The information management unit 604 of the information providing device 110 may perform, for example, a terminal information registration process illustrated in FIG. 9.

FIG. 9 is a flowchart illustrating another example of the terminal information registration process according to an embodiment. In the process illustrated in FIG. 9, the processes at steps S801 to S806 are similar to those of FIG. 8, and thus differences between the process illustrated in FIG. 9 and the process illustrated in FIG. 8 will be described mainly.

At step S901, the information management unit 604 of the information providing device 110 determines whether the object determined to be a predetermined fallen object is a fallen object registered in a database. For example, the information management unit 604 manages fallen objects detected by a plurality of the terminal devices 120 within a preset range (for example, within a radius of 15 m) from the position of a fallen object registered in the database as identical fallen objects.

As another example, the information management unit 604 may determine the item of a fallen object (for example, a tire, a wheel cover, a fallen stone, and a cardboard box) using a prediction model learned in advance by machine learning, and for example, when the items of fallen objects match, these objects are managed as identical fallen objects.

Furthermore, the information management unit 604 may determine whether fallen objects are identical based on the similarity of a plurality of character strings indicating object candidates notified from the above-described Cloud Vision API or the like.

With the above-described process, the information providing device 110 can effectively reduce the risk of managing the identical fallen object as different fallen objects by mistake.

When the object detected by the terminal device 120 and determined to be a predetermined fallen object is not a fallen object registered in the database (“NO” at S901), the information providing device 110 performs the processes at steps S805 and S806. On the other hand, the object detected by the terminal device 120 and determined to be a predetermined fallen object is a fallen object registered in the database (“YES” at S901), the information providing device 110 performs the processes at steps S902 and S903.

At step S902, the information management unit 604 of the information providing device 110 adds 1 to the detection number of the fallen object registered in the database. The information management unit 604 can thus manage the number of cases where the identical fallen object is detected.

At step S903, the determining unit 606 of the information providing device 110 averages the position information of the objects determined to be the identical fallen objects and updates the position information of the fallen object registered in the database with the averaged position information. For example, the determining unit 606 calculates the average value of position information by weighting the position information of the fallen object registered in the database and the position information of the object determined to be the identical fallen object as to the detection number.

The determining unit 606 may update position information in the database by calculating not only the average value of a plurality of pieces of the position information but also other representative values such as a mode value and a median.

With the above-described process, the information management unit 604 can efficiently reduce the storage area of the fallen object information about the identical fallen objects. For example, when a plurality of the terminal devices 120 (for example, a plurality of vehicles having the terminal device 120 mounted thereon) detect the identical fallen objects, the image data and position information transmitted from the terminal devices 120 are assumed to have substantially the identical content. With the process illustrated in FIG. 9, it is possible to prevent a large amount of the image data and position information with substantially the identical content from being accumulated in the memory.

### (Third Example of Terminal Information Registration Process)

In the processes illustrated in FIGS. 8 and 9, if it is determined at step S804 that the object captured in the image data included in the terminal information is not a predetermined fallen object, the information providing device 110 ends the process.

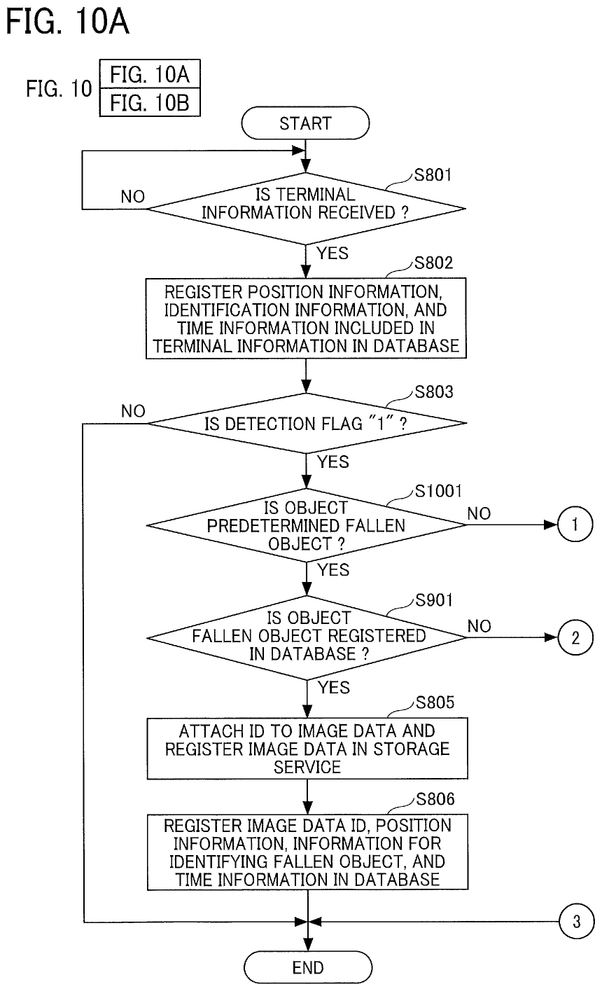

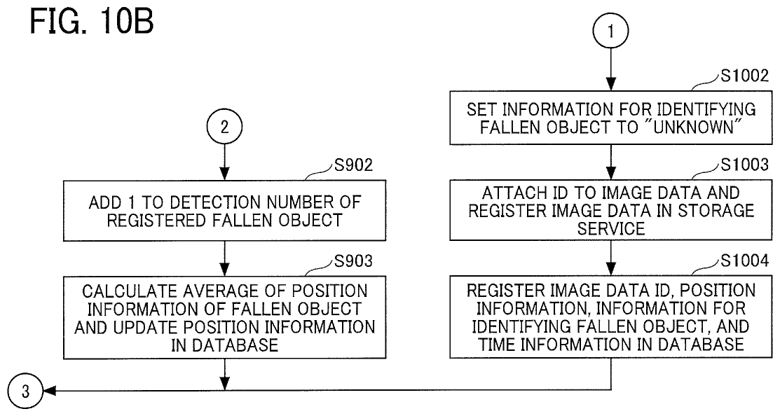

As another example, when it is determined by the process illustrated in FIG. 10 that the object is not a predetermined fallen object, the information management unit 604 of the information providing device 110 may store the image data and position information included in the terminal information in a memory.

FIG. 10 is a flowchart illustrating yet another example of the terminal information registration process according to an embodiment. In the process illustrated in FIG. 10, the processes at steps S801 to S803 and steps S805 and S806 are similar to the processes illustrated in FIG. 8. In addition, in the process illustrated in FIG. 10, the processes at steps S901 to S903 are similar to the processes illustrated in FIG. 9. For this reason, the description of the processes similar to the processes illustrated in FIGS. 8 and 9 will be omitted, and differences between the process illustrated in FIG. 10 and the processes illustrated in FIGS. 8 and 9 will be described mainly.

The determination unit 603 of the information providing device 110 determines at step S1001 whether the object captured in image data included in terminal information is a predetermined fallen object, similarly to step S804 of FIG. 8.

When the object captured in the image data included in the terminal information is a predetermined fallen object, the information providing device 110 performs the processes at steps S805 and S806. On the other hand, if the object captured in the image data included in the terminal information is not a predetermined fallen object, the information providing device 110 proceeds the process to step S1002.

When the process proceeds to step S1002, the information management unit 604 of the information providing device 110 sets the information for identifying a fallen object to, for example, “unknown”.

At steps S1003 and S1004, the information management unit 604 of the information providing device 110 stores fallen object information including the image data and the position information included in the terminal information, and the information for identifying a fallen object (“unknown”) in the memory. For example, at step S1003, the information management unit 604 attaches an ID for identifying image data to the image data included in the terminal information and registers the image data in the storage service 643 of the external server 140 or the like.

At step S1004, the information management unit 604 registers the ID of the image data, the position information included in the terminal information, the information for identifying a fallen object (“unknown”), and the time information included in the terminal information in a database such as the database service 644.

With the above-described process, the information management unit 604 stores, for example, image data of an object that cannot be specified by the image recognition service 642 or a fallen object that is not registered in advance in the information providing device 110 in the memory as an “unknown” fallen object.

As for the “unknown” fallen object, for example, the operator desirably looks at the image of the object, specifies the object, and determines the method of processing the object.

### (First Example of Display Screen Display Process)

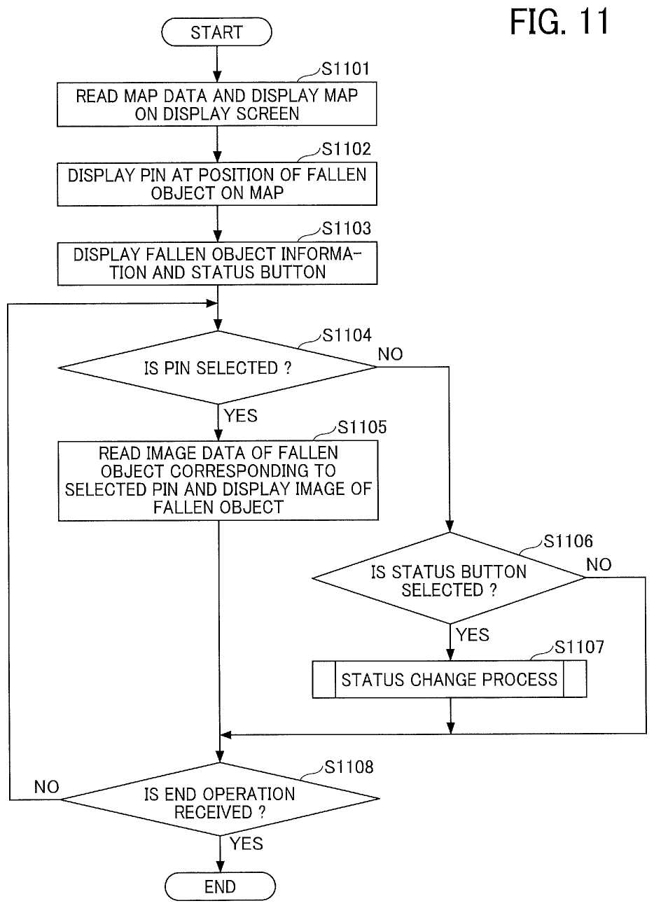

FIG. 11 is a flowchart illustrating an example of a display screen display process according to an embodiment. This process is an example of a process in which the information providing unit 605 of the information providing device 110 uses fallen object information managed by the information management unit 604 to display the display screen 300 for the operator illustrated in FIG. 3 on the web browser 631 of the operator's terminal 130, for example.

The information providing unit 605 of the information providing device 110 performs a display screen display process illustrated in FIG. 11 when the operator accesses a web server provided by the information providing unit 605 using the web browser 631 of the operator's terminal 130.

At step S1101, the information providing unit 605 of the information providing device 110 acquires position information indicating the position of a fallen object from a database managed by the information management unit 604 and reads map data including the position of the fallen object from the storage unit 609 or the external server 140. In addition, the information providing unit 605 displays the map 320 on the display screen 300 illustrated in FIG. 3 using the read map data, for example.

At step S1102, the information providing unit 605 of the information providing device 110 displays the pin 321 indicating the position of the fallen object illustrated in FIG. 3 at the position of the fallen object on the map 320, for example.

At step S1103, the information providing unit 605 of the information providing device 110 displays, for example, the fallen object information 310 and a status button (for example, the “instruct removal” button 311 in FIG. 3) on the display screen 300 illustrated in FIG.3.

The fallen object information 310 includes, for example, information such as “position”, “detection date and time”, “fallen object”, and “detection number”, as illustrated in FIG. 3. The “position” information is displayed using, for example, position information corresponding to the fallen object registered in the database at step S806 of FIG. 9. The “detection date and time” information is displayed using, for example, time information corresponding to the fallen object registered in the database at step S806 of FIG. 9. The “fallen object” information is displayed using information for identifying a fallen object registered in the database at step S806 of FIG. 9. The “detection number” information is displayed, for example, using the information about the detection number counted at step S902 of FIG. 9.

In an initial state of the status button where an operation on the fallen object is not received from the operator, as illustrated in FIG. 3, the “instruct removal” button 311 is displayed, for example.

In this state, for example, when the pin 321 on the display screen 300 illustrated in FIG. 3 is selected at step S1104, the information providing unit 605 performs a process at step S1105.

At step S1105, the information providing unit 605 of the information providing device 110 reads the image data of the fallen object corresponding to the selected pin 321 and, for example, displays the information window 322 of the display screen 300 illustrated in FIG. 3 and the image 323 of the fallen object.

When the image data of the fallen object is stored in the storage service 643 of the external server 140, the information providing unit 605 uses the ID for identifying the image data of the fallen object corresponding to the selected pin 321 to acquire the image data from the storage service 643.

Meanwhile, for example, when the status button (for example, “instruct removal” button 311) on the display screen 300 illustrated in FIG. 3 is selected at step S1106, the information providing device 110 performs a status change process at step S1107. The status change process will be described later with reference to FIG. 14.

At step S1108, the information providing device 110 determines, for example, whether an end operation is received by the operator. If the end operation is not received, the processes at steps S1104 to S1107 are repeatedly performed. On the other hand, when the end operation is received, the information providing device 110 ends the display screen display process.

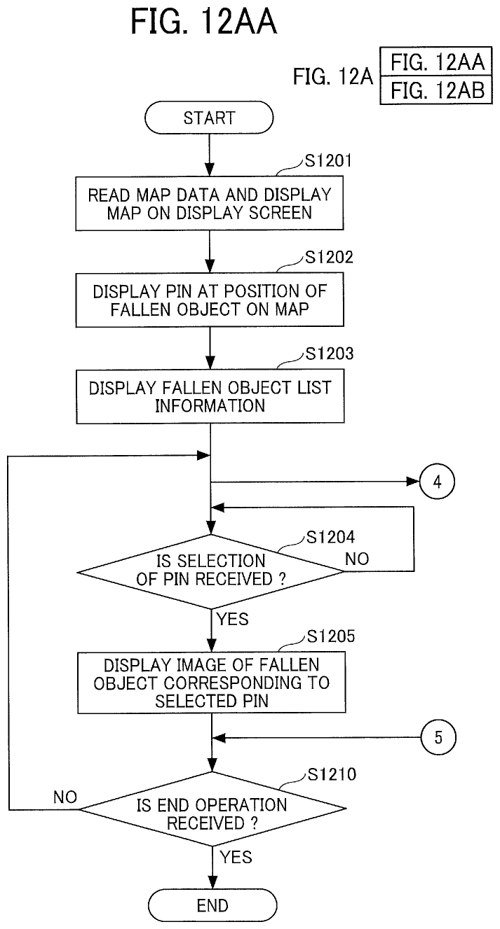

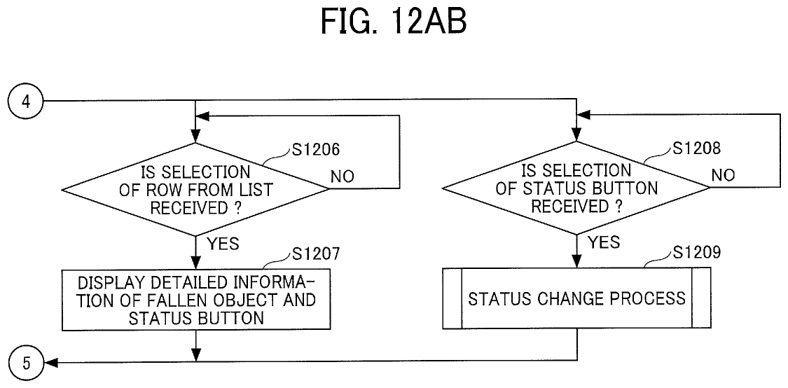

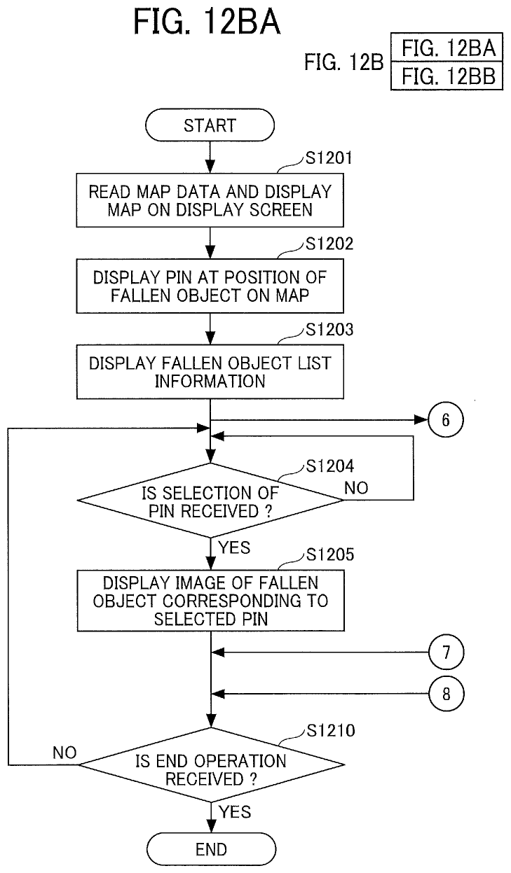

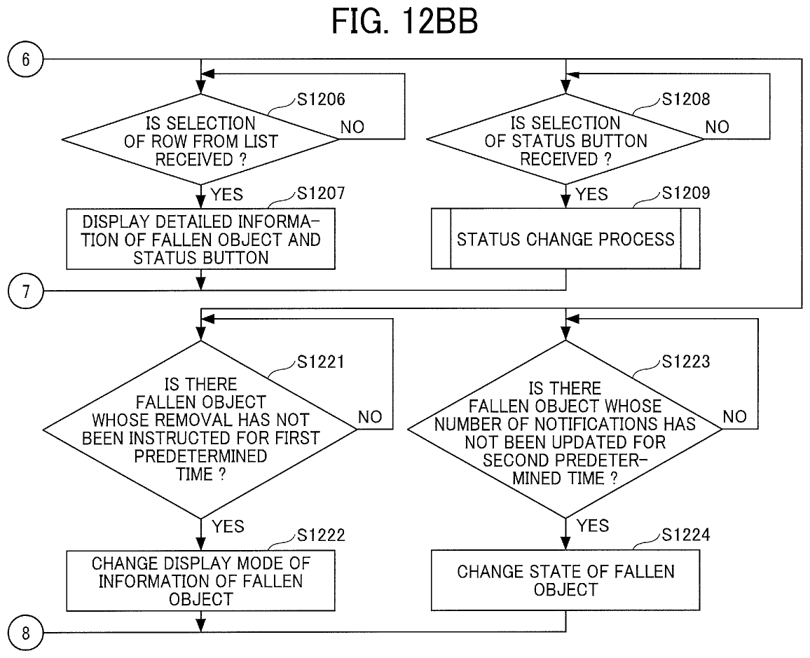

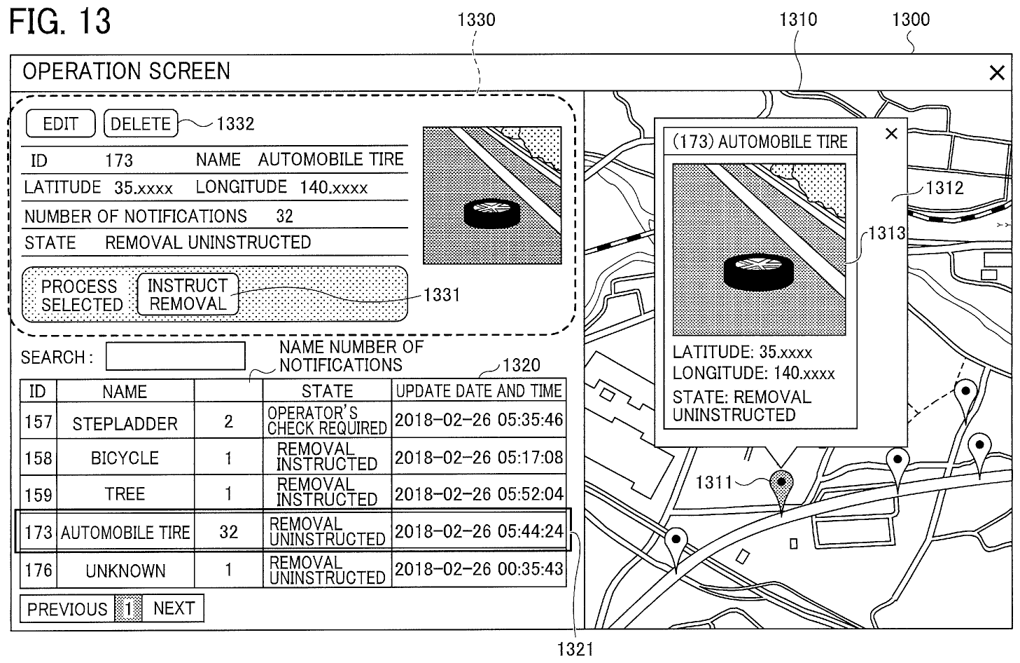

With the above-described process, the information providing device 110 can display, for example, the display screen 300 for the operator illustrated in FIG. 3 on the web browser 631 of the operator's terminal 130. The display screen 300 for the operator illustrated in FIG. 3 is an example. The information providing device 110 may display, for example, a display screen 1300 for the operator illustrated in FIG. 13 on the web browser 631 of the operator's terminal 130 by a display screen display process illustrated in FIG. 12A or 12B.

### (Second Example of Display Screen Display Process)

FIG. 12A is a flowchart illustrating another example of a screen display process according to an embodiment. This process is an example of the process in which the information providing unit 605 of the information providing device 110 uses fallen object information managed by the information management unit 604 to display the display screen 1300 for the operator illustrated in FIG. 13 on the web browser 631 the operator's terminal 130, for example.

The information providing unit 605 of the information providing device 110 may perform the display screen display processes illustrated in FIGS. 12A and 12B instead of the display screen display process illustrated in FIG. 11.

At step S1201, the information providing unit 605 of the information providing device 110 displays a map 1310 on the display screen 1300 illustrated in FIG. 13 similarly to the process at step S1101 of FIG. 11, for example.

At step S1202, the information providing unit 605 of the information providing device 110 displays a pin 1311 indicating the position of the fallen object on the display screen 1300 illustrated in FIG. 13 similarly to the process at step S1102 of FIG. 11, for example.

At step S1203, the information providing unit 605 of the information providing device 110 displays fallen object list information 1320 on the display screen 1300 illustrated in FIG. 13, for example. In the example of FIG. 13, the fallen object list information 1320 includes information such as “ID”, “name”, “number of notifications”, “state”, and “update date and time” for each of fallen objects.

The “ID” information is displayed using, for example, the ID of image data registered in the database at step S806 or step S1104 of FIG. 10.

The “name” information is displayed using, for example, the information for identifying a fallen object registered in the database at step S806 or step S1004 of FIG. 10.

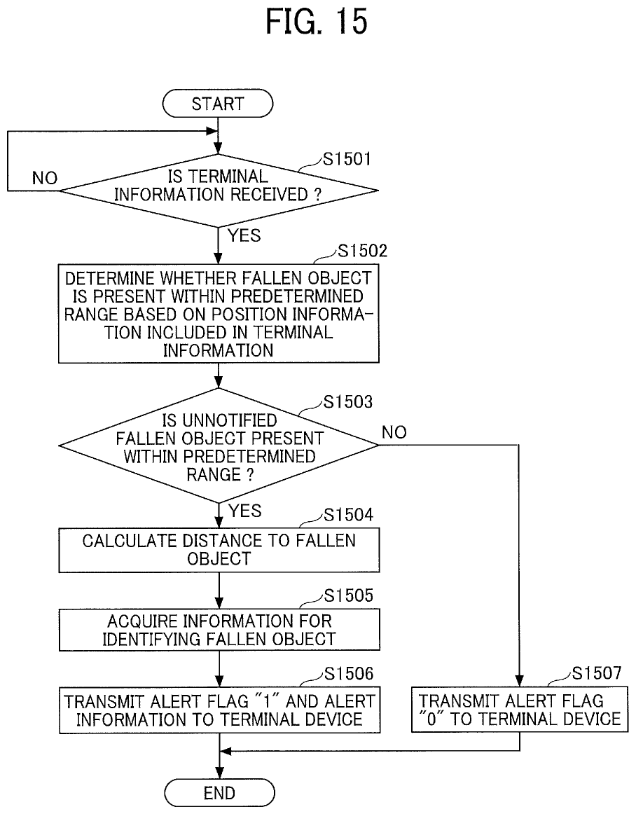

The “number of notifications” information is displayed by the notification unit 608 of the information providing device 110 counting the number of times of notification of alert information about a fallen object through an alert information notification process to be described later with reference to FIG. 15 and using a count value, for example.

The “state” information is displayed using, for example, the state (status) of a fallen object managed by the state management unit 607 of the information providing device 110.

The “update date and time” information is displayed using, for example, the information of the date when the database was last updated at step S806, step S903, or step S1004 of FIG. 10.

In such a state, when the pin 1311 is selected at step S1204, for example, the information providing unit 605 displays an image 1313 of a fallen object corresponding to the selected pin 1311 and an information window 1312, similarly to step S1105 of FIG. 11.

For example, when one row is selected from the fallen object list information 1320 at step S1206, the information providing unit 605 displays at step S1207 detailed information of a fallen object corresponding to the selected row and a status button on the display screen 1300.

For example, when a row 1321 of the ID “173” is selected as illustrated in FIG. 13, the information providing unit 605 displays the detailed information of the fallen object and an “instruct removal” button 1331, which is an example of the status button, that are indicated within a broken line 1330 in FIG. 13.

In addition, for example, when the status button is selected at step S1208, the information providing unit 605 performs a status change process to be described later with reference to FIG. 14 at step S1209.

At step S1210, the information providing device 110 repeatedly performs the processes at steps S1204 to S1209 until receiving an end operation.

### (Third Example of Display Screen Display Process)

FIG. 12B is a flowchart illustrating yet another example of the screen display process according to an embodiment. This process is another example of the process in which the information providing unit 605 of the information providing device 110 uses fallen object information managed by the information management unit 604 to display the display screen 1300 for the operator illustrated in FIG. 13 on the web browser 631 of the operator's terminal 130, for example.

In a screen display process illustrated in FIG. 12B, processes at steps S1221 to S1224 are added to the screen display process illustrated in FIG. 12A. The processes at steps S1201 to S1210 of FIG. 12B are similar to the processes at steps S1201 to 1210 of FIG. 12A, and thus differences between the process illustrated in FIG. 12A and the process illustrated in FIG. 12B will be described mainly.

After the display screen 1300 illustrated in FIG. 13 is displayed at steps S1201 to S1203 of FIG. 12B, the information providing device 110 performs processes at steps S1221 to S1223 in parallel with processes at steps S1204 to S1209.

At step S1221, the information providing unit 605 of the information providing device 110 determines whether there is a fallen object whose state has been “removal uninstructed” for a first predetermined time. For example, the information providing unit 605 determines whether there is a fallen object whose status has been “removal uninstructed” for the first predetermined time (for example, 30 minutes and 1 hour) since the date and time when the fallen object was first detected. When there is a fallen object whose state has been “removal uninstructed” for the first predetermined time, the information providing unit 605 proceeds the process to step S1222.

When the process proceeds to step S1222, the information providing unit 605 changes a display mode of the information of the fallen object whose state is determined to have been “removal uninstructed” for the first time. As an example, when the state of “automobile tire” in the fallen object list information 1320 on the display screen 300 illustrated in FIG. 13 has been “removal uninstructed” for the first time or longer, the information providing unit 605 changes the background color of the row for “automobile tire” or the color of characters to a predetermined color. The information providing unit 605 may change the color of the pin 1311 corresponding to “automobile tire” accordingly.

The method of changing the display mode is not limited to the change of color, and for example, characters may be blinked, increased in size (for example, enlarged), or the thickness of characters may be changed (for example, may be displayed in bold). In these cases, the color and display mode of the pin 1311 may be changed according to, for example, the size of the fallen object whose state is “removal uninstructed” (an example of the information for identifying a fallen object). In other words, the larger the size of the fallen object, the higher the possibility that the fallen object not only obstructs the traffic of vehicles but also endangers the traffic of vehicles. It is thus desirable to use a display mode that prompts the operator operating the operator's terminal 130 to remove the fallen object with priority.

Alternatively, the display color of the pin 1311 may be changed to red (or blinking red or the like), orange, blue, and the like depending on the operation state of the fallen object (removal uninstructed, removal instructed, removal completed, and the like).

With the above-described process, when there is a fallen object for which a removal instruction has not been issued since the detection of the fallen object, the information providing unit 605 is capable of reminding the operator about such a state.

At step S1223, the information providing unit 605 of the information providing device 110 determines whether there is a fallen object whose “number of notifications” has not been updated for a second predetermined time. For example, the information providing unit 605 determines whether there is a fallen object whose “number of notifications” has not changed for the second predetermined time (for example, 30 minutes and 1 hour) since the date and time when the fallen object was last detected. For example, it is assumed that the time for determining that the fallen object is not already present at that place is set in advance in the second time. If there is a fallen object whose number of notifications has not been updated for the second time, the information providing unit 605 shifts the process to step S1224.

When the process proceeds to step S1224, the information providing unit 605 changes “state” of the fallen object whose number of notifications has not been updated for the second time. As an example, when the number of notifications “32” of “automobile tire” in the fallen object list information 1320 on the display screen 300 illustrated in FIG. 13 has not been updated for the second time or longer, the information providing unit 605 changes the state of “automobile tire” to “no notification for predetermined time” (or “unknown” or “removed”).

With the above-described process, when the fallen object is moved by the wind, an animal, a bird or the like and is not detected, the information providing unit 605 is capable of notifying the operator of such a state.

### (Status Change Process)

FIG. 14 is a flowchart illustrating an example of a status change process according to an embodiment. This process is an example of the status change process performed by the information providing device 110 at step S1107 of FIG. 11 or step S1209 of FIGS. 12A and 12B.

For example, when the information providing unit 605 receives at step S1401 selection of a “removal required” button that is an example of the status button on the display screen 1300 for the operator illustrated in FIG. 13, the information providing device 110 performs a process at step S1402.

The “removal required” button is displayed on the display screen 1300 for the operator together with a “no removal required” button when the information for identifying a fallen object is “unknown”.

At step S1402, the state management unit 607 updates the status (management state) of the fallen object to “removal uninstructed” and the information providing unit 605 displays the “instruct removal” button 1331 on the display screen 1300 for the operator accordingly.

When the information providing unit 605 receives at step S1403 selection of the “instruct removal” button 1331 on the display screen 1300 for the operator, the information providing device 110 performs a process at step S1404.

At step S1404, the state management unit 607 updates the status of the fallen object to “removal instructed” and the information providing unit 605 displays a “removal completed” button that is an example of the status button on the display screen 1300 for the operator.

When the information providing unit 605 receives at step S1405 selection of the “removal completed” button on the display screen 1300 for the operator, the information providing device 110 performs a process at step S1406.

At step S1406, the state management unit 607 updates the status of the fallen object to “processed”. In response thereto, the information providing unit 605 deletes the information of the fallen object from the display screen 1300 for the operator, for example.

When the information providing unit 605 receives at step S1407 selection of a “removal unnecessary” button on the display screen 1300 for the operator, the information providing device 110 performs the above-described process at step S1406.

In this way, the state management unit 607 of the information providing device 110 can manage the status (management state) of a fallen object according to the operation of the status button by the operator.

When the status of a fallen object is updated to “processed”, the information providing device 110 may transmit alert information indicating that the fallen object has been removed to the terminal device 120 that has notified the information providing device 110 of the information about the fallen object.

According to the present embodiment, with the processes of FIGS. 7A and 7B to FIGS. 12A and 12B and FIG. 14, it is possible to provide the information providing system 100 that facilitates timely collection of information of fallen objects on a wide range of roads at low cost.

### (Alert Information Notification Process)

FIG. 15 is a flowchart illustrating an example of an alert information notification process according to an embodiment. This process is an example of a process performed when the information providing device 110 receives terminal information from the terminal device 120, and for example, is performed in parallel with the terminal information registration process illustrated in FIGS. 8 to 10.

At step S1501, when the information providing device 110 receives terminal information transmitted from the terminal device 120, the information providing device 110 performs the processes at step S1502 and subsequent steps.

At step S1502, the notification unit 608 of the information providing device 110 determines whether a fallen object that has not been notified to the terminal device 120 is present within a predetermined range (for example, within a radius of 2 km) set in advance based on the position of the terminal device 120 based on the position information included in the terminal information.

Note that the fallen object that has not been notified to the terminal device 120 is a fallen object whose alert information has not notified to the terminal device 120 that has transmitted the terminal information. The predetermined range may be other ranges.

At step S1503, the notification unit 608 of the information providing device 110 branches the process depending on whether there is an unnotified fallen object within the predetermined range. If there is an unnotified fallen object within the predetermine range, the notification unit 608 shifts the process to step S1504. On the other hand, if there is no unnotified fallen object within the predetermined range, the notification unit 608 shifts the process to step S1507.

When the process proceeds to step S1504, the notification unit 608 of the information providing device 110 calculates the distance between the terminal device 120 and the fallen object using the position information of the terminal device 120 included in the terminal information and the position information of the fallen object.

At step S1505, the notification unit 608 acquires information for identifying a fallen object managed by the information management unit 604 (for example, the name, type, and size of a fallen object).

At step S1506, the notification unit 608 transmits an alert flag “1” indicating that there is a fallen object and alert information including the distance to the fallen object and the information for identifying the fallen object to the terminal device 120 that has transmitted the terminal information.

As an example, the alert information including the distance to the fallen object and the information for identifying the fallen object may include a text message such as “There is automobile tire with a diameter of 70 cm (one example of fallen object) within 1.5 km (one example of distance to fallen object), so drive carefully.” The alert information is not limited thereto, and may include information indicating the distance to a fallen object, information indicating the type of a fallen object (code of fallen object), and information indicating the arrival time to a fallen object.

When the process proceeds from step S1503 to step S1507, the notification unit 608 transmits an alert flag “0” indicating that there is no fallen object to the terminal device 120 that has transmitted the terminal information.

With the above-described process, the information providing device 110 can provide the alert information about a fallen object near the terminal device 120 to the terminal device 120 that has transmitted the terminal information.

### (Voice Information Output Process)

FIG. 16 is a flowchart illustrating an example of a voice information output process according to an embodiment. This process is an example of a process performed when the terminal device 120 receives the information transmitted by the information providing device 110 at step S1506 or step S1507 of FIG. 15.

At step S1601, when the terminal device 120 receives the information transmitted by the information providing device 110 at step S1506 or step S1507 of FIG. 15, the terminal device 120 performs processes at step S1602 and subsequent steps.

At step S1602, the voice output unit 626 of the terminal device 120 determines whether the alert flag of the information received from the information providing device 110 is “1” or “0”. If the alert flag is “1”, the voice output unit 626 shifts the process to step S1603. On the other hand, when the alert flag is “0”, the voice output unit 626 ends the process.

When the process proceeds to step S1603, the voice output unit 626 acquires alert information from the information received from the information providing device 110. For example, the voice output unit 626 acquires a text message included in the alert information such as “There is automobile tire within 1.5 km. Drive carefully.” Alternatively, the voice output unit 626 may acquire information indicating the distance to a fallen object, information indicating the type of a fallen object, and information indicating the size of a fallen object included in the alert information.

At step S1604, the voice output unit 626 generates an alert voice based on the acquired alert information and outputs the generated alert voice. For example, the voice output unit 626 converts the acquired text message into a voice by a voice synthesis process and outputs the voice. Alternatively, the voice output unit 626 may select, among voice messages stored in advance, a voice message for the information indicating the distance to a fallen object, the information indicating the type of a fallen object, or the information indicating the size of a fallen object included in the alert information, and output the selected voice message. In this case, the volume of the voice message may be controlled according to the various information described above.

With the above-described processes of FIGS. 15 and 16, when there is a fallen object near a user of the terminal device 120 (for example, driver), the user can receive alert information about the fallen object as a voice message. The user of the terminal device 120 utilizing the information providing system 100 attaches the terminal device 120 to the dashboard 201 of the vehicle 101, for example, as shown in FIG. 2 to execute an application for the information providing system 100.

According to the present embodiment, for example, information of a fallen object on a road is collected timely from other terminal devices 120 by the processes of FIGS. 7A and 7B to FIG. 10, and thus the user of the terminal device 120 can always acquire alert information about the latest fallen object.

According to the present embodiment, the alert information of a fallen object is notified and a voice is output only to a vehicle approaching the fallen object among vehicles traveling on a road. For example, it is assumed that the alert information of the fallen object is not notified and the voice is not output to a vehicle that has passed the fallen object.

According to the present embodiment, it is possible to provide the information providing system 100 that facilitates timely collection of information of fallen objects on a wide range of roads at low cost.

According to the information providing system 100 of the present embodiment, the operator who monitors roads can easily acquire the information of a fallen object on a road to be managed without traveling around the roads using a management vehicle.

In addition, a worker who removes or collects fallen objects on roads can refer to a display screen for the operator illustrated in FIGS. 3 and 13 and immediately go to the location where a fallen object has fallen without going around the roads using the management vehicle. Consequently, it is possible to remove or collect quickly the fallen object. The operator who manages roads can reduce the cost of travelling a management vehicle.

In another example, a worker who collects fallen objects on roads may determine the location of a fallen object by referring to the display screen for the operator illustrated in FIGS. 3 and 13, and collects the fallen object using a drone or the like.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. An information providing system comprising:
one or more terminal devices that are respectively mounted on one or more vehicles; and
an information processing apparatus communicable with the terminal devices via a network, wherein
each of the terminal devices includes first circuitry configured to detect an object on a road and transmit terminal information including captured image data in which the object is captured and position information indicating a position where the object is detected to the information processing apparatus, and
the information processing apparatus includes second circuitry configured to
receive the terminal information from at least one of the terminal devices that has detected the object on the road,
determine whether the object in the captured image data included in the terminal information is a predetermined fallen object,
when the object is determined to be the predetermined fallen object, register the captured image data and the position information included in the terminal information that is received, and information for identifying the fallen object, in a memory as fallen object information of the fallen object, and
provide information on the fallen object, based on the registered fallen object information.

2. The information providing system according to claim 1, wherein the second circuitry controls a display to display a screen including at least one of the position information indicating a position of the fallen object, the information for identifying the fallen object, and an image of the fallen object.

3. The information providing system according to claim 2, wherein
the fallen object information further includes a state of the fallen object,
the second circuitry controls the display to further display, on the screen, information indicating the state of the fallen object, and
in response to reception of a user instruction for changing the state of the fallen object through the screen, changes the state of the fallen object registered based on the user instruction.

4. The information providing system according to claim 1, wherein when an object in the captured image data is determined to be the predetermined fallen object and is present within a predetermined range from a position of one registered fallen object, the second circuitry determines the object in the captured image data to be identical to the one fallen object.

5. The information providing system according to claim 4, wherein
the second circuitry obtains a number of the fallen objects each having been detected and determined to be identical to the one fallen object and
obtains a representative value of position information indicating positions of the fallen objects as position information of the one fallen object.

6. The information providing system according to claim 1, wherein
the first circuitry of each of the terminal devices transmits position information indicating a position of each of the terminal devices or the vehicle to the information processing apparatus at a predetermined time, and
when the fallen object is present within a predetermined range from the position of each of the terminal devices or the vehicle, the second circuitry of the information processing apparatus notifies each of the terminal devices of alert information indicating that the fallen object is present.

7. The information providing system according to claim 6, wherein the first circuitry of each of the terminal devices outputs voice information for prompting a driver to call attention to the fallen object based on the alert information notified from the information processing apparatus.

8. An information processing apparatus communicable with one or more terminal devices that are respectively mounted on one or more vehicles, the information processing apparatus comprising circuitry configured to:
receive terminal information from at least one of the terminal that has detected an object on a road, the terminal information including captured image data in which the object is captured and position information indicating a position where the object is detected;
determine whether the object in the captured image data included in the terminal information is a predetermined fallen object;
when the object is determined to be the predetermined fallen object, register the captured image data and the position information included in the terminal information that is received, and information for identifying the fallen object, in a memory as fallen object information of the fallen object; and
provide information of the fallen object, based on the registered fallen object information.

9. The information processing apparatus according to claim 8, wherein the circuitry controls a display to display a screen including at least one of the position information indicating a position of the fallen object, the information for identifying the fallen object, and an image of the fallen object.

10. The information processing apparatus according to claim 8, wherein
the fallen object information further includes a state of the fallen object,
the circuitry controls the display to further display, on the screen, information indicating the state of the fallen object, and
in response to reception of a user instruction for changing the state of the fallen object through the screen, changes the state of the fallen object registered based on the user instruction.

11. The information processing apparatus according to claim 8, wherein when an object in the captured image data is determined to be the predetermined fallen object and is present within a predetermined range from a position of one registered fallen object, the circuitry determines the object in the captured image data to be identical to the one fallen object.

12. The information processing apparatus according to claim 11, wherein
the circuitry obtains a number of the fallen objects each having been detected and determined to be identical to the one fallen object and
obtains a representative value of position information indicating positions of the fallen objects as position information of the one fallen object.

13. The information processing apparatus according to claim 8, wherein
the circuitry receives, from each of the terminal devices, position information indicating a position of each of the terminal devices or the vehicle at a predetermined time, and
when the fallen object is present within a predetermined range from the position of each of the terminal devices or the vehicle, notifies each of the terminal devices of alert information indicating that the fallen object is present.

14. An information providing method, performed by an information processing apparatus communicable with one or more terminal devices that are respectively mounted on one or more vehicles, the method comprising:
receiving terminal information from at least one of the terminal that has detected an object on a road, the terminal information including captured image data in which the object is captured and position information indicating a position where the object is detected;
determining whether the object in the captured image data included in the terminal information is a predetermined fallen object;
wherein, when the determining determines that the object is the predetermined fallen object, the method further comprising:
registering the captured image data and the position information included in the terminal information that is received, and information for identifying the fallen object, in a memory as fallen object information of the fallen object; and
providing information of the fallen object, based on the registered fallen object information.
